(19) United States
(12) Patent Application Publication
(10) Pub. No.: US 2012/0011751 A1
(43) Pub. Date: Jan. 19, 2012

(54) Customized Audio Greeting Cards In A Retail Store

(76) Inventors: Scott A. Schimke, Leavenworth, KS (US); Jennifer Cameron Black, Mission, KS (US); Mark J. Reichert, Kansas City, MO (US)

(21) Appl. No.: 12/836,500

(22) Filed: Jul. 14, 2010

(51) Int. Cl. G09F 1/00

(52) U.S. Cl. 40/124.03

(57) ABSTRACT

An audio greeting card is typically manufactured with pre-recorded songs that play when the greeting card is opened. The purchaser of an audio greeting card is limited to the songs already selected for such cards. A customizable audio greeting card is provided, for which the user can select the audio that is played. The audio greeting card has an audio receiving and playback device, with a connector for receiving audio information. User-selected audio information is sent to the greeting card and identifiable information is generated pertaining to the sent audio information. The identifiable information may be printed onto a label for affixing to the greeting card or may be printed directly onto the greeting card. The identifiable information is utilized when completing the sale of the customized greeting card, thereby indicating the finalized customization of the user-selected audio played on the purchased audio greeting card.

### CROSS-REFERENCE TO RELATED APPLICATIONS

Not applicable.

### STATEMENT REGARDING FEDERALLY SPONSORED RESEARCH OR DEVELOPMENT

Not applicable.

### BRIEF SUMMARY OF THE INVENTION

Audio greeting cards typically play pre-recorded songs loaded onto the cards at the time of manufacture. By including particular, pre-recorded songs that are already loaded on cards, coordinating the payment of royalties for the songs is simplified. Although a purchaser of an audio greeting card may select a particular card with a certain pre-recorded song, or in some instances record a personal voice message onto the card, a purchaser may still desire to further customize the greeting card prior to delivery to its intended recipient. Giving a purchaser the opportunity to select the particular song that a greeting card plays could be problematic when coordinating the payment of royalties, which are based on the completed sale of the customized greeting card.

In an effort to provide a customizable audio greeting card, while still ensuring that royalties may be coordinated for the audio played on the customized card, the present invention permits a user to select audio for playback on an audio greeting card while also facilitating the identification and tracking of the purchased audio and customized card. In one embodiment of the present invention, an audio greeting card is provided with an audio receiving and playback device coupled to the card body. The device includes a connector for receiving audio information, such as a purchaser selected song.

In yet another embodiment, an aspect of the invention relates to a method of sending audio information to greeting cards using an audio sending device. An audio sending device receives a greeting card coupled to an audio information and playback device. The audio information and playback device has a connector that can be connected to the audio sending device. A user selects specific audio information, such as a song, that the user would like the greeting card to play. The audio sending device then sends the selected audio information to the greeting card. The audio sending device then generates identifying information regarding the audio information that was sent to the card. Such identifying information may be printed onto a label, or printed directly onto the greeting card.

In still another embodiment, an aspect of the invention is directed to a system for sending audio information to greeting cards. The system includes an audio greeting card for receiving audio information, an audio sending component for sending audio information to the greeting card, and a purchasing component for receiving identifying information generated by the audio sending component. The greeting card includes a connector capable of being connected to and receiving audio information from the audio sending component. The audio sending component generates identifiable information regarding the audio information sent to the card, and in some embodiments, prints the audio information on a label or directly onto the greeting card.

### BRIEF DESCRIPTION OF THE DRAWINGS

The features of the invention noted above are explained in more detail with reference to the embodiments illustrated in the attached drawing figures, in which like reference numerals denote like elements, in which FIGS. 1-6 illustrate several possible embodiments of the present invention, and in which:

FIG. 1 is a perspective view of the back panel of a partially-opened greeting card constructed in accordance with an embodiment of the present invention and with a flap in a lowered position;

FIG. 2 is a perspective view of the greeting card of FIG. 1 with the flap in the raised position;

FIG. 3 is a perspective view of the greeting card of FIG. 2 with identifying information attached to the greeting card;

FIG. 4 is an enlarged, fragmentary view of a portion of the back panel of the greeting card of FIG. 3 with the flap raised to reveal the connector;

FIG. 5 is a side elevation of an interior of the greeting card of FIG. 1 with a portion of a cover panel cut-away to reveal electrical components of the greeting card;

FIG. 6 is a flow diagram showing a method for sending audio information to greeting cards in accordance with an embodiment of the present invention;

FIG. 7 is a block diagram of an exemplary system in which embodiments of the invention may be employed;

FIG. 8 is a perspective view of the back panel of a partially-opened greeting card constructed in accordance with an alternate embodiment of the present invention and with a labeling area;

FIG. 9 is a side elevation of an interior of the greeting card of FIG. 8 with a portion of a cover panel cut-away to reveal electrical components of the greeting card;

FIG. 10 is a front elevation view of an exemplary card display with a plurality of greeting cards, in accordance with an embodiment of the present invention;

FIGS. 11-12 are enlarged, fragmentary views of the center of the card display of FIG. 10;

FIG. 13 is a top plan view of an exemplary retail download station constructed in accordance with an embodiment of the present invention;

FIG. 14 is an enlarged, fragmentary view of a portion of the download station of FIG. 13;

FIG. 15 is a rear, side view of the download station of FIG. 13 coupled to a printer station;

FIGS. 16-17 illustrate another view of the download station of FIG. 13 with a greeting card loaded into the station at differing amounts;

FIG. 18 illustrates the download station of FIG. 13 with a greeting card loaded into the station and a portion of both the download station and the greeting card cut-away to reveal electrical components of the download station and the greeting card;

FIG. 19 is an enlarged, fragmentary view of a portion of the interior of the download station of FIG. 13 and a portion of the interior of the greeting card to illustrate alignment of components when the card is loaded into the download station; and

FIG. 20 is a perspective view of the back panel of the greeting card of FIG. 8 with identifying information affixed to the labeling area.

### DETAILED DESCRIPTION OF THE INVENTION

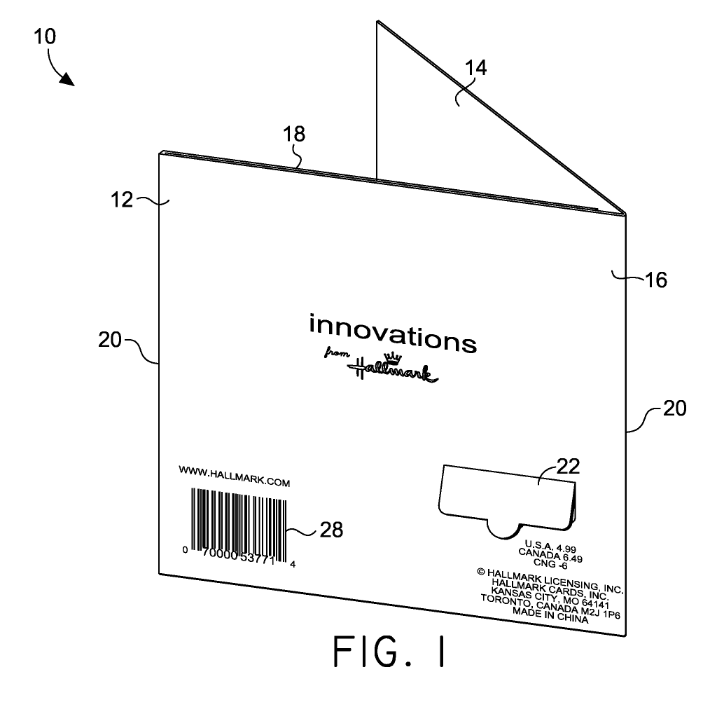

Referring now to the drawings in more detail and initially to FIG. 1, numeral 10 generally designates a greeting card constructed in accordance with an embodiment of the present invention. The greeting card 10 includes a card body 12. In this illustrated example, the card body 12 includes a front panel 14, a back panel 16, and an interior cover panel 18. As readily understood by one of ordinary skill in the art, the card body 12 may consist of a single piece of card stock that has been folded along fold lines 20 to provide panels 14, 16, and 18, as depicted in the illustrated embodiment. It would also be readily understood that panels 14, 16, and 18 may be individual panels that are joined to one another by any number of methods known in the art, and that the card body 12 could have any number of panels.

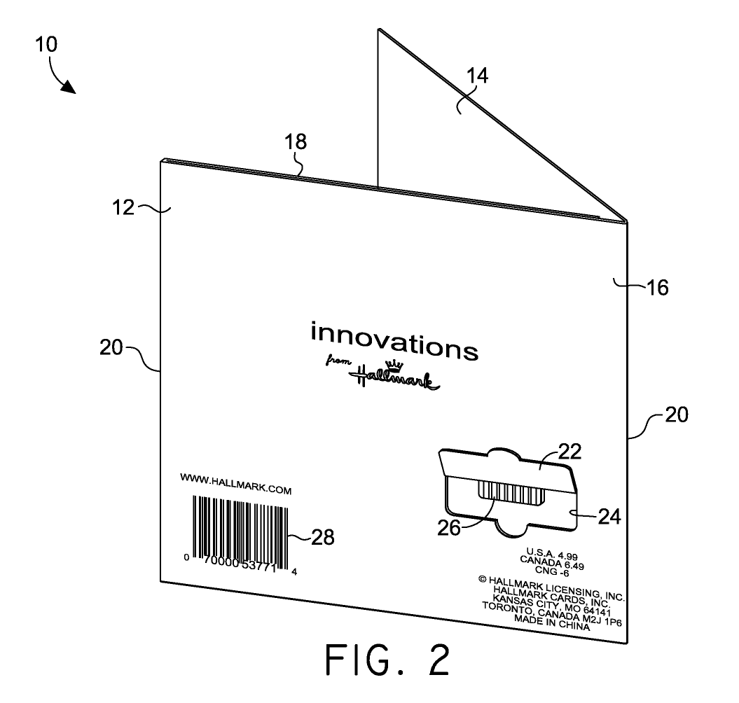

A flap 22 is also provided and is preferably coupled with the card body 12. In the illustrated embodiment, the flap 22 is a part of and is cut out of the back panel 16, and is therefore also a part of the card blank that forms the card body 12. As illustrated in FIG. 2, the flap 22 may be raised so that a connector 26 may be accessed through an opening 24. As will be understood, in some embodiments, the card body 12 does not include a flap 22 covering the connector 26. As such, the connector 26 may be accessible from any number of openings in the card body 12, as is contemplated within the scope of the present invention.

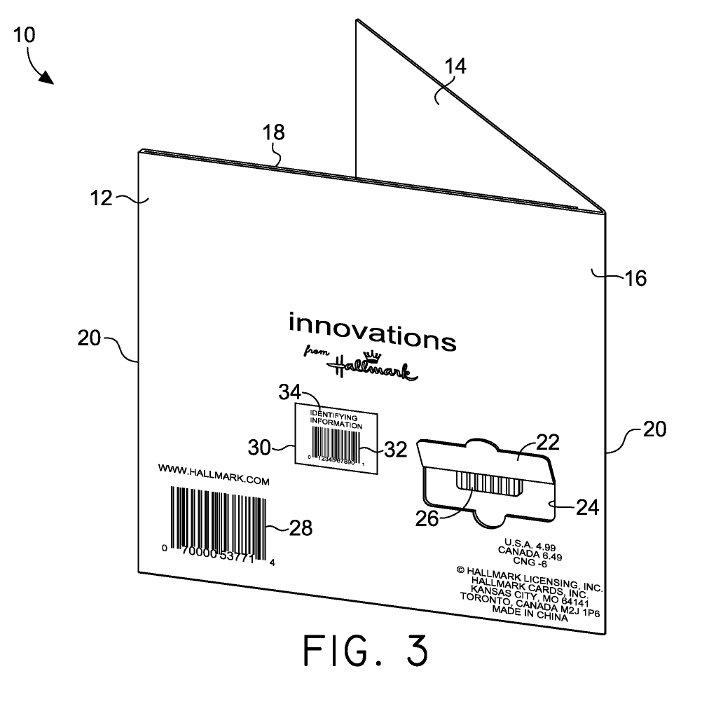

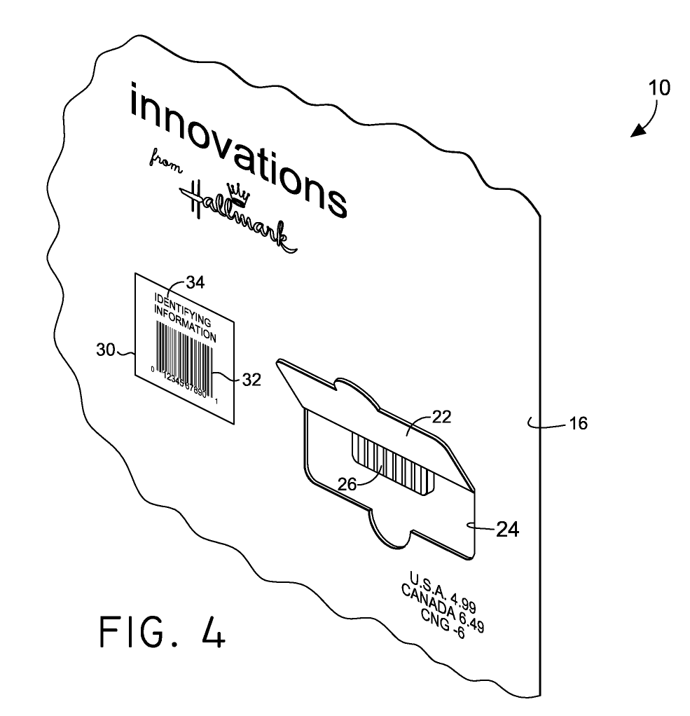

As further illustrated in FIGS. 3 and 4, identifying information 30 is affixed to the back panel 16 of card body 12. In further embodiments, identifying information 30 is printed directly onto back panel 16. Identifying information 30 may include identification wording 34, an identification marking 32, or both. For example, identification wording 34 may be the name of an artist associated with the purchaser selected audio information, while an identification marking 32 may be a universal product code (UPC) that provides an indication of audio information. Similarly, identifying information 30 may include any number of indicators pertaining to the audio information that has been sent to the greeting card 10, such as, for example, the title of the song, the name of the artist, the name of the author, copyright information, ownership information, licensing information, and legal information.

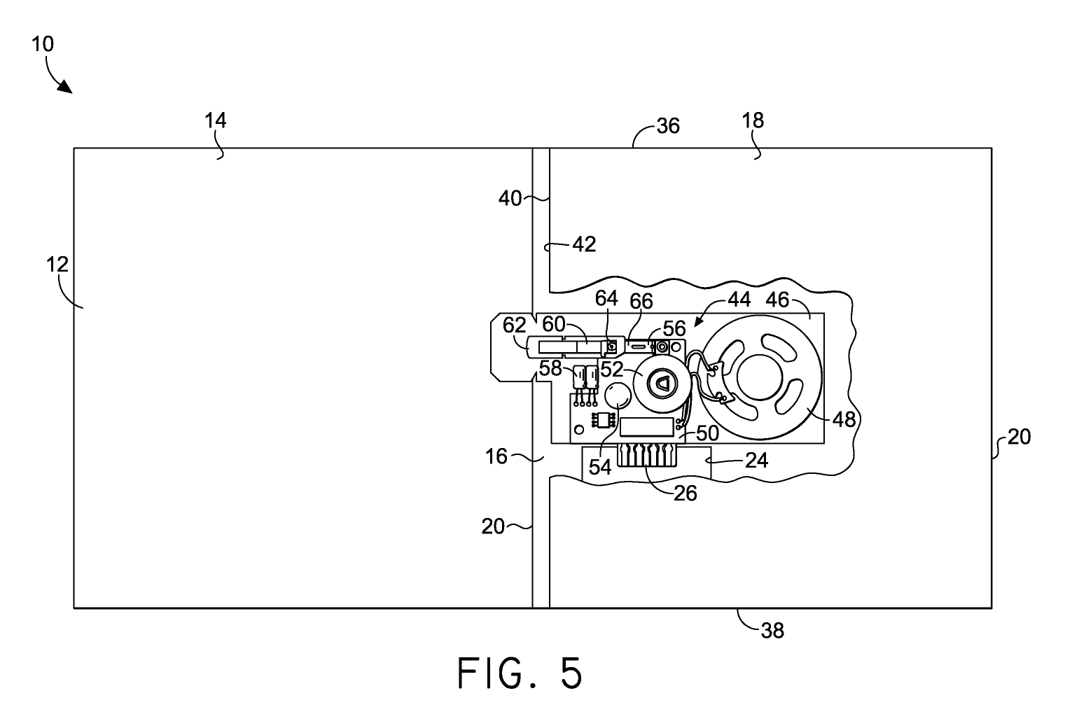

Turning now to FIG. 5, the interior of the greeting card 10 is illustrated. The interior panel 18 has been folded such that it overlaps the back panel 16. The interior panel 18 and the back panel 16 have been secured together along an upper edge 36 of the card body 12 and along a lower edge 38 of the card body 12. An edge 40 of the card body 12 has been left unsecured to the back panel 16. As such, the interior panel 18 and back panel 16 define a pocket or cavity 42 into which an audio receiving and playback device may be positioned.

As further illustrated in FIG. 5, the audio receiving and playback device 44 is shown. The audio receiving and playback device 44, for ease of manufacture and assembly of the greeting card 10, may be provided on a carrier 46. The carrier 46 can then be adhered to the inner surfaces of the front and back panels 14 and 16. Alternatively, the components of the audio receiving and playback device 44 may be individually positioned inside the pocket 42.

The audio receiving and playback device 44 preferably includes the connector 26, a speaker 48, a circuit board 50, a power supply 52, an integrated circuit 54, and a first switch 56 configured to activate an audio message playback session of the audio receiving and playback device 44. In addition to the electrical components mentioned, which are coupled to the circuit board 50, other electrical components 58 are coupled with the circuit board 50 as would be readily understood and appreciated by one of ordinary skill in the art.

In the illustrated embodiment, the first switch 56 has been implemented as a slide switch 56. The slide switch 56 includes a contact arm 66 which is biased into engagement with a contact surface (not shown) on the circuit board 50. The slide switch 56 also includes a slide tab 60 that is moveable between a first position (when the card is in a closed position), where a portion of the slide tab 60 is intermediate the contact arm 66 and the contact surface of the circuit board 50, thereby creating an open circuit, and a second position, illustrated in FIG. 5, where the greeting card 10 is in an open position and an aperture 64 in the slide tab 60 permits the contact arm 66 to abut the contact surface of the circuit board 50, thereby creating a closed circuit. A proximal end 62 of the slide tab 60 is coupled, either directly or indirectly, with the inner surface of the front panel 14, whereby movement of the front panel 14 away from the interior panel 18 (i.e. opening the card) pulls the slide tab 60 out from between the contact arm 66 and the contact surface of the circuit board 50 and whereby subsequent closing of the greeting card 10 (i.e. moving the front panel 14 towards the interior panel 18) moves the slide tab 60 back between the contact arm 66 and the contact surface of the circuit board 50.

In embodiments, the audio receiving and playback device 44 also includes a microphone and a second switch configured to activate an audio message recording session. In such an embodiment, a purchaser of the greeting card 10 would be able to add their own personal, audio message recording to the greeting card 10. Accordingly, a single device could perform the operations of both an audio receiving and playback device 44 and an audio message recording and playback device. Further, components of the audio receiving and playback device may be combined, such as, for instance, combining a speaker 48 with a microphone.

It is to be understood that a separate audio message recording and playback device could be provided on a carrier 46 inside the greeting card 10, and include a microphone, and a second switch for activating an audio message recording feature. As such, a separate audio message device could also include a separate power supply and a separate speaker from the audio receiving and playback device.

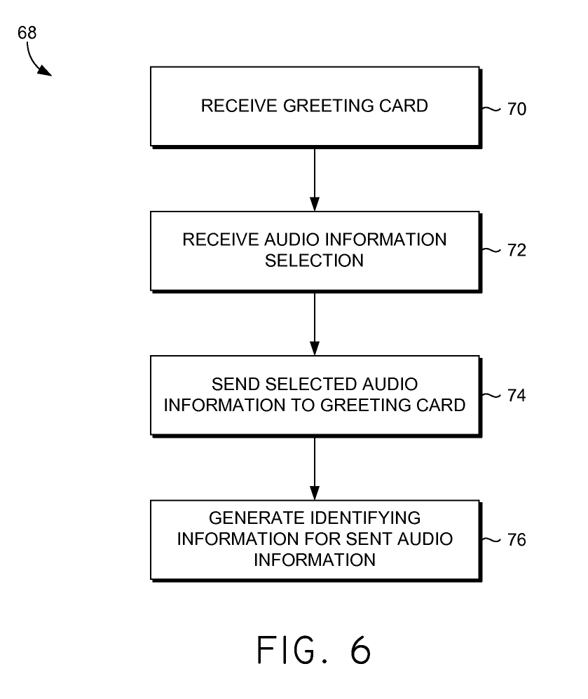

Turning now to FIG. 6, a method 68 for sending audio information to greeting cards using an audio sending device is shown. At block 70, a greeting card is received. Receiving a greeting card 10 may include an audio sending device receiving the connecting component of an audio receiving and playback device 44 coupled to a greeting card 10, such as the connector 26 illustrated in FIGS. 2-5. For example, an audio sending device may take the form of a “kiosk” in a retail store. In such case, a connector 26 of the audio receiving and playback device 44 in a greeting card 10 may be directly coupled to the kiosk. In embodiments, the purchaser of a greeting card 10 connects the connector 26 of the greeting card directly to the audio sending device in a retail store. As previously discussed with reference to FIG. 4, a connector 26 may be accessed through the back panel 16 of a greeting card 10 or, in other embodiments, accessed through another opening in the greeting card 10. Alternatively, a cord or patch cord, detachable or otherwise, could be used to couple the connector 26 or the audio receiving and playback device 44 to the audio sending device. In other embodiments, the connection could be wireless.

As shown at block 72, an audio information selection is received. Receiving an audio information selection may include receiving a selection from a purchaser indicating particular audio information for the audio sending device to send to the greeting card. Examples of such audio information include a song, a sound clip, a sound recording, a WAV file, a MIDI file, an MP3 file, information for playback of a song already stored on the greeting card, and the like. As will be understood by one of ordinary skill in the art, audio information may include any number of audio formats that are capable of being played by an audio receiving and playback device.

At block 74, the selected audio information is sent to the greeting card. Sending audio information to the greeting card 10 may also be referred to as “downloading,” “uploading,” “communicating,” or “transferring” audio information to the greeting card. Sending of audio information may be a unidirectional delivery, a bidirectional delivery, or both. The audio sending device simply sends the selected audio information to the greeting card that receives the audio information. For example, as used here interchangeably, the terms “sending” or “communicating” are not meant to require any interaction between the greeting card and the audio sending device, other than the receipt of the sent or communicated audio information.

Based on the audio information sent to the greeting card, as shown at block 76, identifying information 30 is generated for the sent audio information. Such identifying information 30 may include the name of a song sent to the greeting card, the name of an artist that performed the song sent to the greeting card, or any other identifying information 30 associated with the selected audio information sent to the greeting card, as discussed above. Identifying information 30 may be printed on a label to be adhered to the back of the greeting card, or may be printed directly onto one of the panels of a greeting card, preferably the back panel.

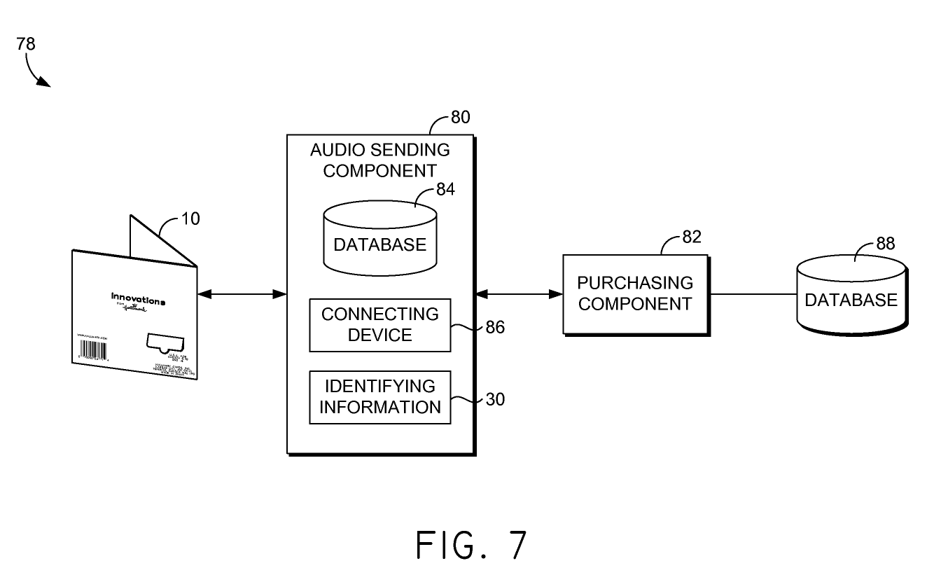

Referring next to FIG. 7, a system 78 for sending audio information to greeting cards is shown. System 78 generally includes an audio greeting card 10, an audio sending component 80, and a purchasing component 82. Each component may comprise a single component or multiple components. As such, the audio sending component 80 may comprise multiple devices that collectively provide the functionality of the audio sending component 80. Additionally, other components not shown may also be included within the system 78. It will be understood and appreciated by those of ordinary skill in the art that the system 78 shown in FIG. 7 is merely an example of one suitable system for sending audio information to greeting cards and is not intended to suggest any limitation as to the scope of use or functionality of the present invention. Neither should the system 78 be interpreted as having any dependency or requirement related to any single component or combination of components illustrated therein.

Generally, the system 78 illustrates an environment in which the audio greeting card 10 receives audio information from an audio sending component 80. The audio sending component 80 may include a database 84 of audio information for sending to the audio greeting card 10. As previously discussed, audio information sent to a greeting card may include songs selected by a user, audio files, audio recordings, instructions for playback of audio information stored on a greeting card, and other information for facilitating the playback of audio upon opening an audio greeting card. As is known in the art, the audio sending component 80 may be referred to as a “kiosk.” For example, a user may access a kiosk 80 to select audio information that the user wants to have played on an audio greeting card 10.

The audio sending component 80 may include a connecting device 86 for sending audio information to or through a connector 26 on the audio greeting card 10. In embodiments, the audio greeting card 10 includes the connector 26, as previously shown in FIGS. 2-4. The connector 26 of the audio greeting card 10 may be accessed through the flap 22 in the greeting card. As such, the connector 26 may be coupled directly to the connecting device 86 of the audio sending component 80.

Having sent audio information to the greeting card 10, the audio sending component 80 may also generate identifying information 30 associated with the sent audio information. The audio sending component 80 may generate identifying information 30 on a label to adhere to the back of the greeting card 10. Alternatively, the identifying information 30 may be printed directly onto the back of the greeting card 10 by the audio sending component 80. In embodiments, the identifying information 30 generated by the audio sending component 80 may be stored in a database 88 for retrieval by a centralized database of information.

The system 78 also includes a purchasing component 82, which may be any standard cash/wrap station, as is known in the art. As illustrated, the purchasing component 82 receives information from the audio sending component 80. In particular, purchasing component 82 receives the identifying information 30 generated by audio sending component 80. This can be accomplished by scanning an identification marking 32 of the identifying information 30 printed on the label or greeting card 10. In embodiments, the purchasing component 82 communicates information regarding the purchase of greeting cards, specifically the identifying information 30 associated with an audio greeting card purchase, to a database 88. The purchasing component 82 may include a scanning device or data entry device, as is known in the art, for completing the transaction of an audio greeting card 10 sale, such as by scanning a UPC bar code 28 of the greeting card 10.

As available in a retail store, an audio greeting card 10 may be selected by a user. This greeting card 10 may include artwork preprinted on the exterior and interior of the card, but may not yet be able to play audio for the user. In embodiments, upon connecting the greeting card 10 to the audio sending component 80, or kiosk, the user is prompted to select an item of audio information for playback on the greeting card 10. By connecting the greeting card 10 to the kiosk 80, the kiosk 80 is able to send the selected audio information directly to the greeting card 10, thereby creating a customized audio greeting card. In further embodiments, the kiosk 80 may also permit a user to enter a customized message to be provided on an identifying information label. In other embodiments, the kiosk 80 may permit the user to record their own custom audio message to be sent to the greeting card 10 for playback.

In order to complete the purchase of the customized audio greeting card 10, the kiosk 80 generates identifying information 30 associated with the audio information that was sent to the customized greeting card 10. Such identifying information may include identification marking 32 and/or identification wording 34, such as a UPC, a song title and artist name, and/or licensing information. The greeting card 10, in the illustrated embodiment, already includes its own identifying information. Such identifying information may include the stock-keeping unit (SKU) number from the particular greeting card selected for customization and its own UPC, such as illustrated in FIGS. 1-3 and 7 at numeral 28. By having identifying information related to both the audio information and the particular card being customized, the particular audio chosen for a particular card may be tracked. For example, the song “Celebrate” may be selected by a user to customize a birthday greeting card. As such, the identifying information 30 for this card 10 would include both information relating to the selected song (i.e. a UPC code that identifies the song “Celebrate”) and information relating to which birthday card was chosen (i.e. the SKU of the particular birthday greeting card selected).

In embodiments, a sales clerk at the purchasing component 82 scans the UPC code 28 of the greeting card 10, as well as the UPC code 32 (or other information) of the identifying information 30. This entry of information relating both to the purchased card and the sent audio information allows tracking of audio files used for licensing purposes and insight into consumer pairing of songs with cards, as well as completes the transaction of the sale of the customized greeting card 10.

Many variations can be made to the illustrated embodiments of the present invention without departing from the scope of the present invention. Such modifications are within the scope of the present invention. For example, identifying information 30 may be transmitted directly to the purchasing component 82, without the need to generate a label to affix to the audio greeting card 10. Similarly, identifying information 30 may be affixed to or printed on other portions of the card body 12, as the invention is not limited to the display of identifiable information on the back panel 16. Additionally, while the connector 26 is illustrated as being exposed from the rear of back panel 16, other locations on the greeting card 10 that permit access to the connector (such as accessing the connector from a bottom edge or the interior panel of the card) are possible and within the scope of the present invention. Further, while the identifying information 30 has been disclosed, in one embodiment, as being printed on an adhesive label to facilitate affixing the label to the back of the card 10, the label could be a non-adhesive label, such as a simple piece of paper (like a receipt) that is merely associated with the card and can accompany it to a check-out station. Further still, the “label” could be simply a display of the identifying information 30 on a monitor, screen, or other visual display of the audio sending component or kiosk 80. Such monitor, screen or other visual display could be the same vehicle by which the audio sending component or kiosk 80 displays audio information available for sending to the greeting card.

In still a further embodiment, a modified audio sending component or kiosk 80 could be used that incorporates the purchasing component 82 therein. The kiosk could have a bar code reader therein that is positioned to align with the UPC code 28 of the greeting card 10 while it is received in the audio sending device or kiosk 80 for transfer of the audio information to the audio receiving and playback device 44 of the greeting card 10 (e.g., when the connector 26 is coupled with the kiosk 80). At some point before, during and/or after the transfer of the audio information to the card, the kiosk could get the desired information from the card 10 by scanning the UPC code 28. That information could then be used as in the other embodiments. The user could then also pay for the card 10 at the kiosk 80. The identifying information 30 could then be printed on a receipt issued by the kiosk 80. Such a modified kiosk 80 would be useful where the identifying information 30 is merely displayed on a monitor. Other modifications would be within the scope of the present invention.

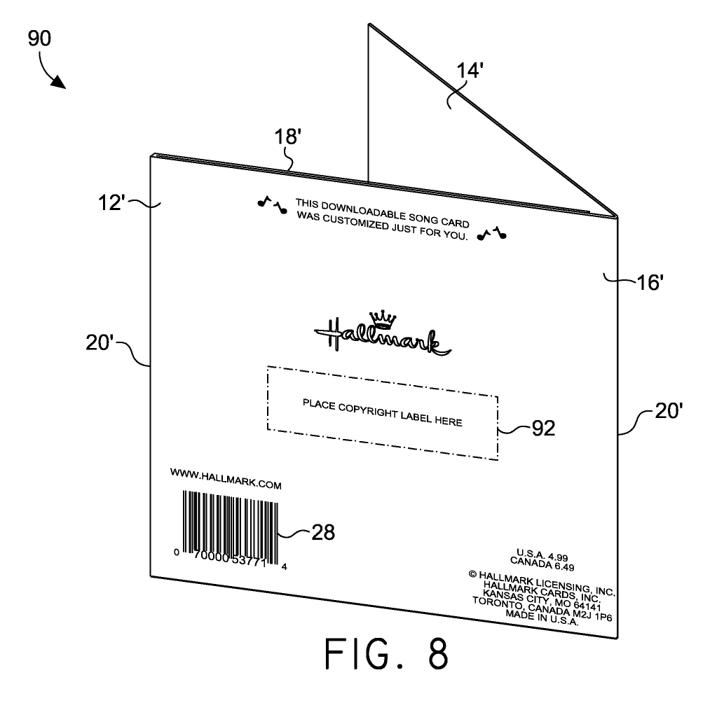

Turning now to FIG. 8, another exemplary embodiment of the present invention is shown. Numeral 90 generally designates a greeting card constructed in accordance with an alternate embodiment of the present invention. The greeting card 90 includes a card body 12′. In this illustrated example, the card body 12′ includes a front panel 14′, a back panel 16′, and an interior cover panel 18′. As will be readily understood by one of ordinary skill in the art, the greeting card 90 shares some similar elements to those depicted in greeting card 10. However, instead of accessing an audio receiving and playback device 44 through a flap on the back panel 16 of greeting card 10, the audio receiving and playback device 44′ of this greeting card 90 is accessed through the pocket 42′ formed between interior cover panel 18′ and back panel 16′. A labeling area 92 is also provided on the greeting card 90, and is preferably designated on the back panel 16′. The labeling area 92 may be used to affix identifying information 30′. As will be understood, in some embodiments, the labeling area 92 is located on a different portion of the card body 12′ of the greeting card 90.

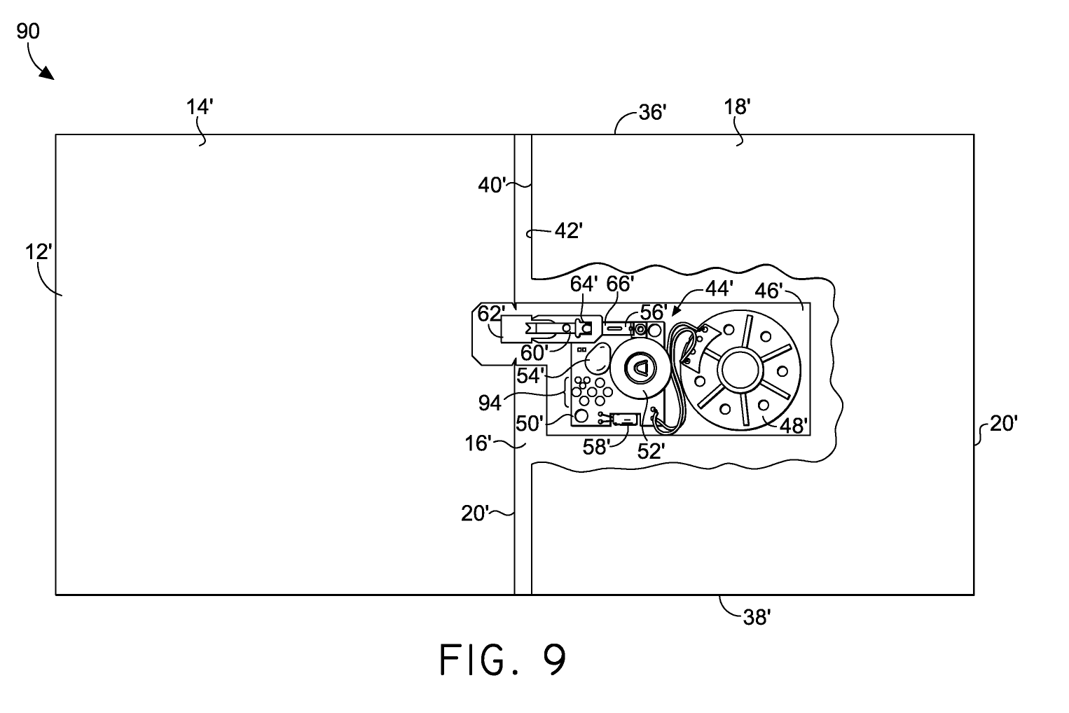

Referring next to FIG. 9, the interior of the greeting card 90 is illustrated. The interior panel 18′ has been folded such that it overlaps the back panel 16′. The interior panel 18′ and the back panel 16′ have been secured together along an upper edge 36′ of the card body 12′ and along a lower edge 38′ of the card body 12′. An edge 40′ of the card body 90 has been left unsecured to the back panel 16′. As such, the interior panel 18′ and back panel 16′ define a pocket or cavity 42′ in to which an audio receiving and playback device 44′ may be positioned.

As further illustrated in FIG. 9, the audio receiving and playback device 44′ is shown. As will be understood, the audio receiving and playback device 44′ of greeting card 90 includes similar components to those included in the audio receiving and playback device 44 of greeting card 10. Such similar components are designated by the prime symbol (“′”) where like components are related. The audio receiving and playback device 44′ of greeting card 90 also includes an electrical connection surface, such as Pogo pin head connectors 94. As will be explained later, the Pogo pin head connectors 94 are capable of being electronically connected directly to male Pogo pin head connectors 182 located on a Pogo pin head 180.

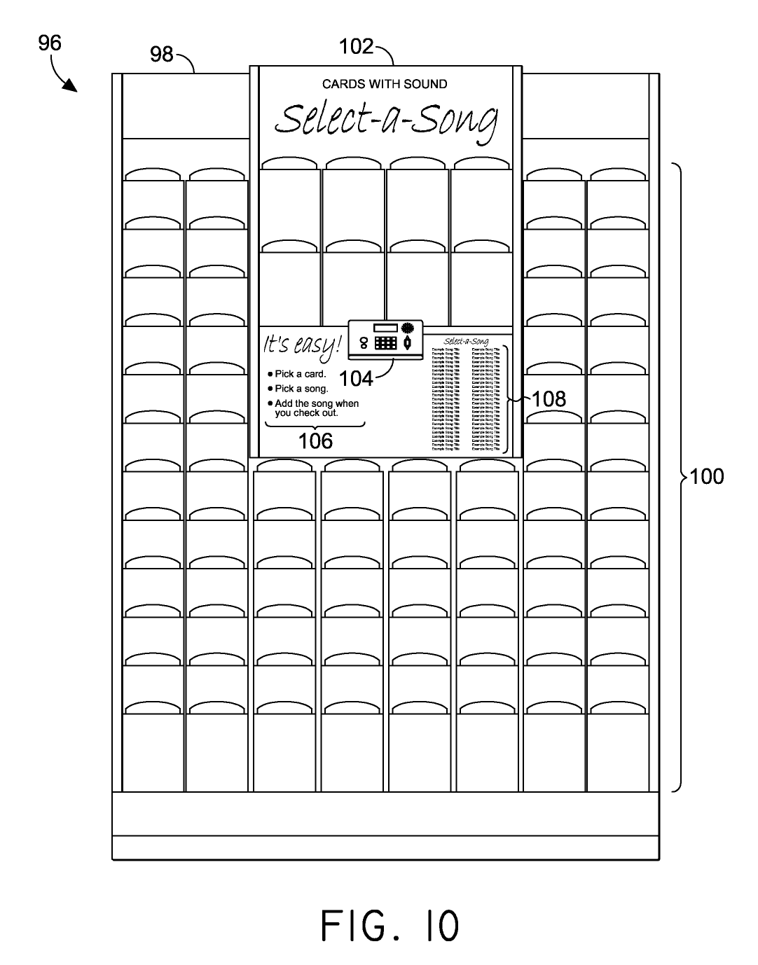

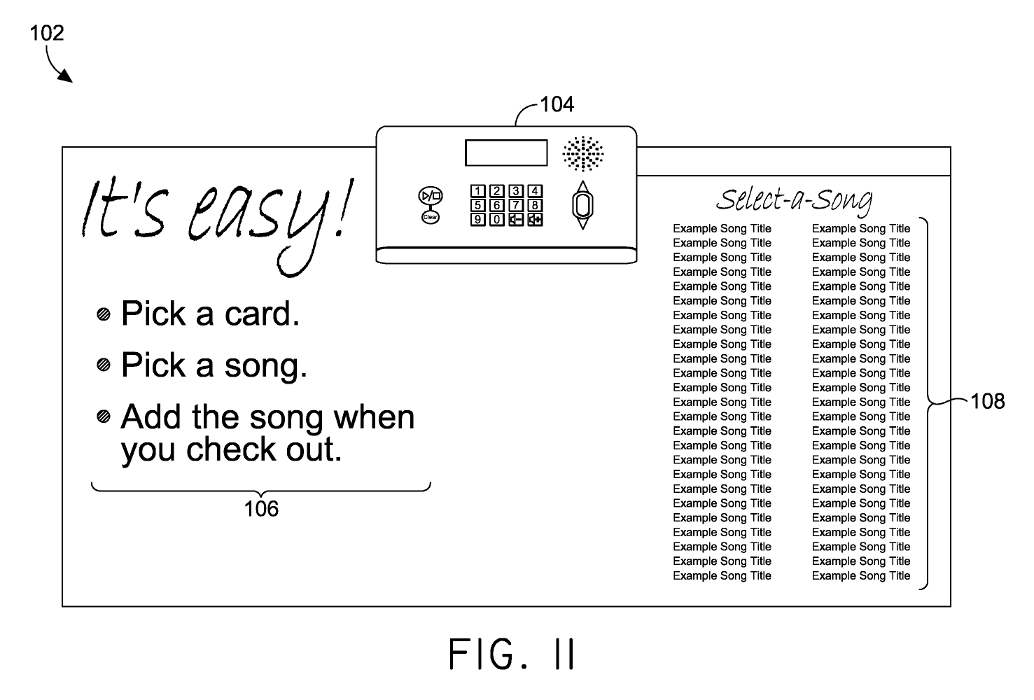

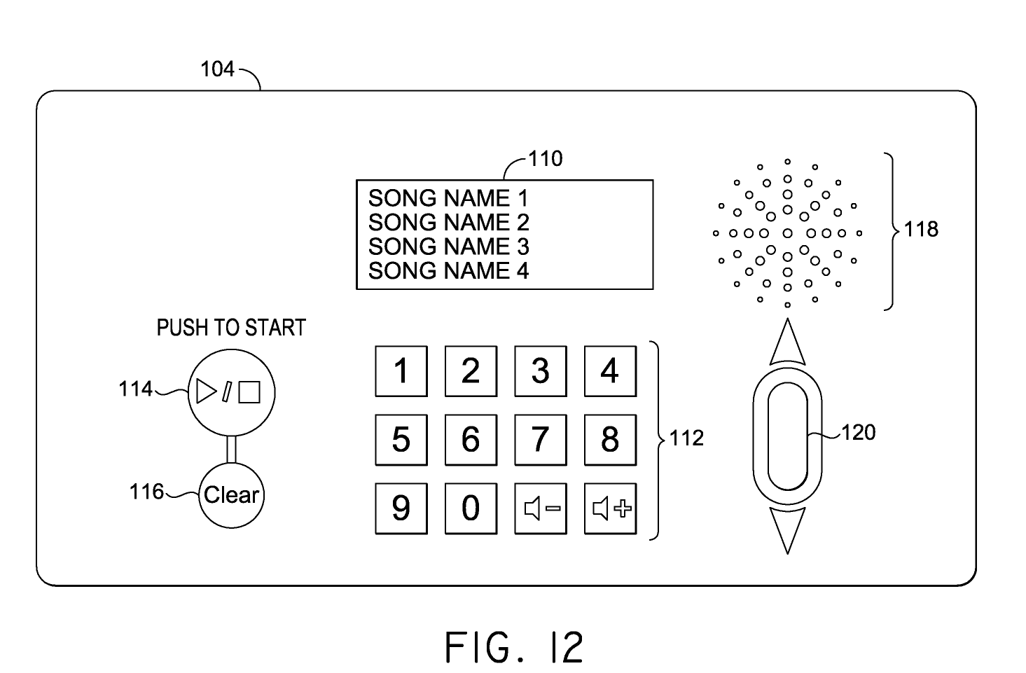

With reference now to FIG. 10, a card display fixture 96 is illustrated. The card display fixture 96 generally includes a frame 98 and a plurality of rows 100 for holding greeting cards. In the illustrated display, in accordance with an embodiment of the present invention, the display fixture 96 also includes a center display section 102 for displaying greeting cards 10, 90 of the present invention. The rows 100 are utilized to support greeting cards for display on the frame 98 of the card display fixture 96. The center display 102 also includes a song preview station 104, an instruction area 106, and an audio selection area 108. Portions of the display center 102 are enlarged in FIGS. 11-12 to show details of the center display 102 and song preview station 104. As best illustrated in FIG. 12, the song preview station 104 includes a song display area 110, a keypad 112, a play/stop button 114, a clear button 116, a speaker 118, and a scroll wheel 120. As shown, the keypad 112 includes both numbered buttons and volume control buttons.

In one embodiment, a purchaser of a greeting card 90 may select the greeting card 90 from the center display section 102 of the display fixture 96. Having selected the particular greeting card 90 that the purchaser wishes to customize, the purchaser then utilizes various aspects or features of the center display 102 to determine which song the user wants to have played back when the greeting card 90 is opened. Following the instructions on the instruction area 106, the purchaser may select a song from a list of available songs in the audio selection area 108. Based on the selected song, the purchaser can then utilize the song preview station 104 to hear an audible preview of the selected song. For example, the purchaser may be deciding between three potential songs to download onto the greeting card 90. By entering the number of a song (determined from the audio selection area 108) into the song preview station 104 using the keypad 112, the entered song is identified on the song display 110 and the purchaser is able to listen to all or a portion of the selected song out of the speaker 118 of the song preview station 104. Alternatively, using the scroll wheel 120, the purchaser may scroll through the list of available songs on the song display 110 of the song preview station 104. Having scrolled to a selected song, the user may then preview the song using the play/stop button 114.

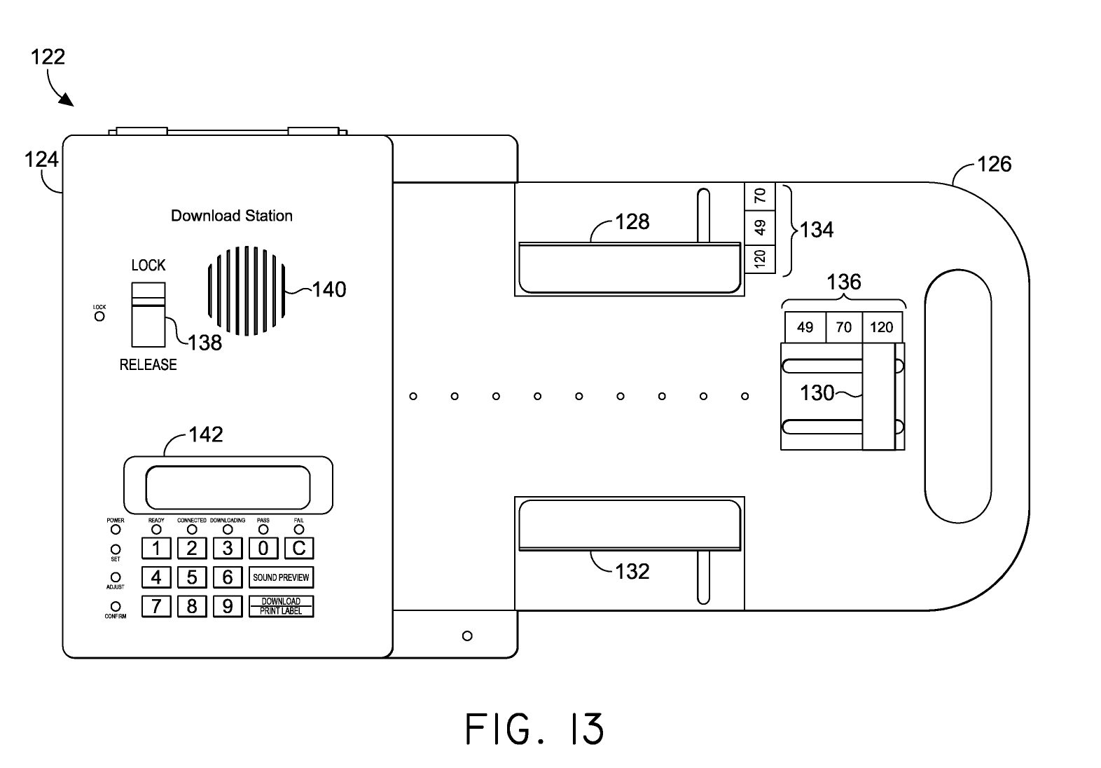

Having determined which song the purchaser would like to have their selected greeting card 90 play upon opening, the purchaser then takes the greeting card 90 to a cashier's station to have the selected song downloaded onto the greeting card 90. As shown in FIG. 13, in this embodiment, a retail download station 122 is used to download a selected song onto a greeting card 90. The retail download station 122 includes a station base 124 and a slide tray 126. The slide tray 126 includes card feeders 128, 130, and 132. Card feeders 128, 130, and 132 are used to guide a greeting card 90 into the station base 124 of the retail download system 122. In one embodiment, card feeders 128 and 130 include card feeder adjustors 134 and 136. The card feeder adjusters 134 and 136 are utilized to move the card feeders 128, 130, and 132 to correspond to the size of the greeting card 90 that will be positioned on the slide tray 126. For example, card feeder adjusters 134 and 136 may be used to adjust the spacing between the card feeders 128, 130, and 132 to accommodate a 49-size, 70-size, or 120-size greeting card 90. In one embodiment, adjusting the card feeder adjusters 134 and 136 involves pulling the card feeder adjusters upward, shifting them to the desired location, and releasing the card feeder adjusters 134 and 136, whereby they lock in place.

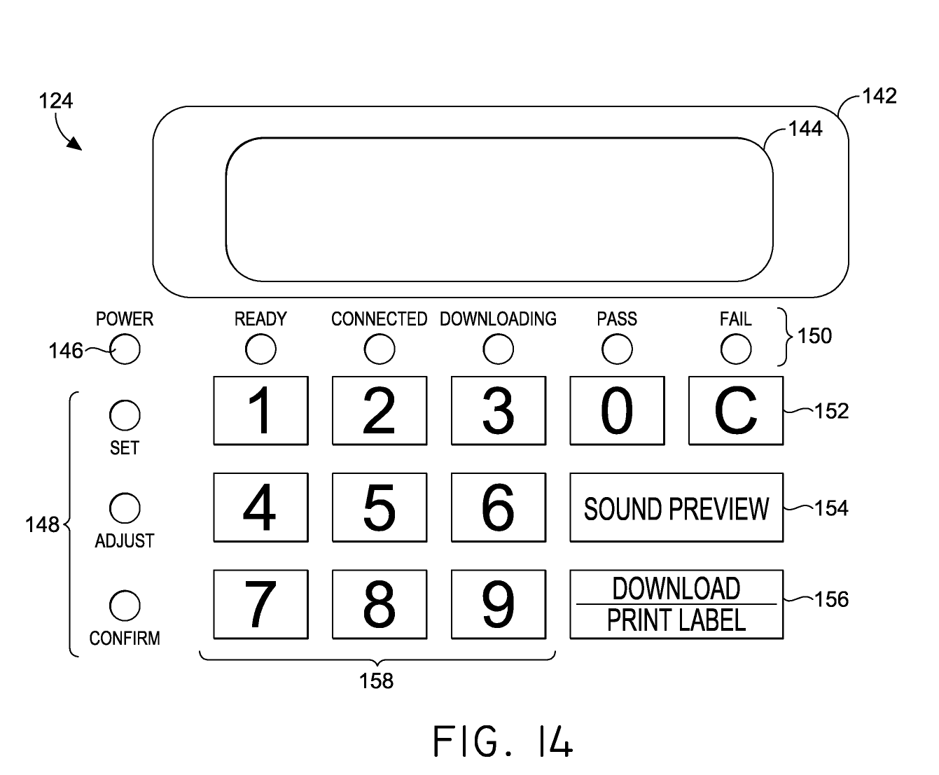

As shown in FIGS. 13-14, the station base 124 includes a lock switch 138, a speaker 140, a song display 142, an LCD screen 144, a power indicator 146, a set of setting keys 148, a set of LED download status indicators 150, a clear button 152, a sound preview button 154, and a download/print label button 156. The station base 124 also includes a set of ten numeric buttons (0-9) which are generally designated by the number 158. The set of setting keys 148 includes a set button, an adjust button, and a confirm button. The set of LED download status indicators illuminate when the retail download station is “ready,” when the system is “connected,” when the system is “downloading,” when the system generates a “pass” result, and when the system generates a “fail” result.

The clear button 152 is a functional button used when the incorrect song is entered into the station base 124 using the numeric buttons 158. The sound preview button 154 is used to preview a song selection entered into the station base 124 using the numeric buttons 158 and played over the speaker 140 of the station base 124. As such, the purchaser of the card can confirm that the song that was previewed and selected at song preview station 104 will be the same song that is downloaded onto the greeting card 90. The download/print label button 156 is used to initiate the downloading of the selected song to the greeting card 90, and also initiates the printing of a label with identifying information 30′ associated with the selected song.

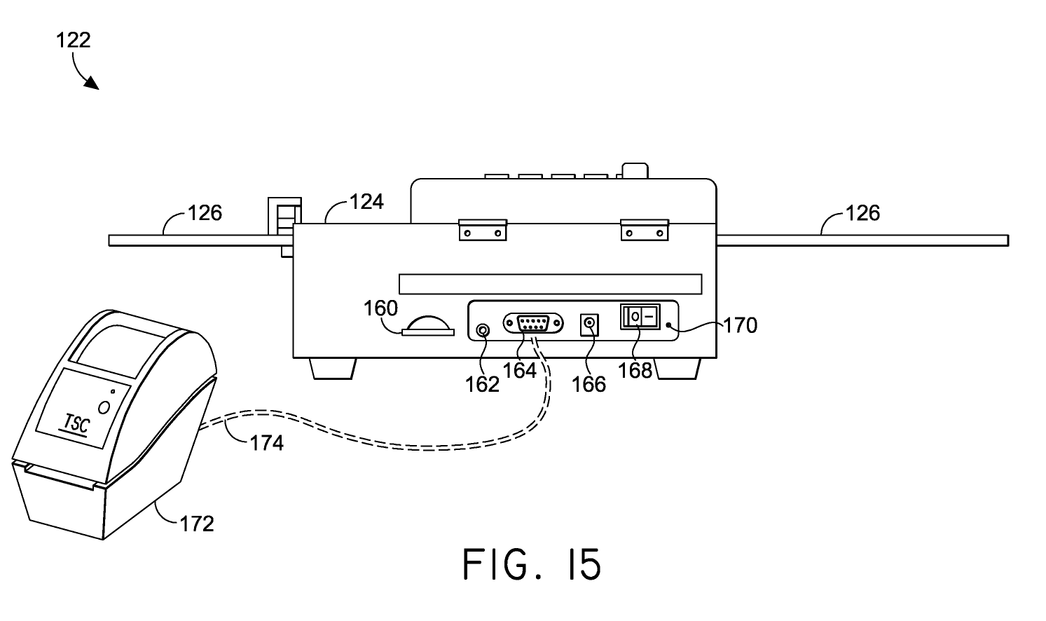

Turning now to FIG. 15, the back side of the station base 124 of the retail download station 122 is shown. The back side of the station base 124 includes a memory card slot, such as SD card slot 160, an audio connector 162, a printer port 164, a power jack 166, a power switch 168, and a reset key 170. As will be understood, any of these components may be located on any surface of the retail download station 122, and are not limited to the rear portion of the station base 124. Further, it will be understood that additional or fewer components could be included and that components that perform equivalent functions could be substituted.

The memory card slot 160 receives a memory card upon which the available songs are stored in electronic format as files available for downloading to the greeting card 90. A similar or identical card may be received in the song preview station 104. As such, the list of available songs can be updated by switching out the memory cards in the retail download station 122 and the song preview station 104. The memory card may also contain the identifying information 30′ that is associated with the available songs and which is printed out upon downloading of a selected song to the greeting card 90.

While the retail download station 122 and the song preview station 104 have been described as having removable memory cards, such as an SD card, the memory may be any type of computer-readable media operable to store data or information and, thus, could comprise any type of volatile or non-volatile memory medium, including random access memory (“RAM”), read only memory (“ROM”), electronically erasable programmable read only memory (“EEPROM”), combinations of the foregoing thereof, and the like. In some embodiments, the memory may be permanently affixed inside the retail download station 122 and the song preview station 104, while in other embodiments the memory may be removable. For embodiments in which the memory is wholly or partially removable, the memory may comprise, for example only, a memory card such as CompactFlash, Secure Digital (“SD”), miniSD or microSD, SmartMedia, Memory Stick, and so on. In embodiments employing, in whole or in part, rewriteable computer-readable media for memory , the contents of memory may optionally be updated via any data connection, including, for example only, physical connections (e.g., conductive wiring, optical links, and the like), logical connections (e.g., radio frequency, including Bluetooth®, WiFi®, WiFi, UWB, and so on), or a combination thereof.

In the illustrated embodiment, the retail download station 122 is coupled to a printer 172 using a connection 174. The connection 174 may be a wired connection, such as a cable connected between the printer port 164 and the printer 172, or a wireless connection. In one embodiment, the printer 172 is used to print identifying information 30′ onto a label that is to be affixed to the back panel 16′ of the greeting card 90.

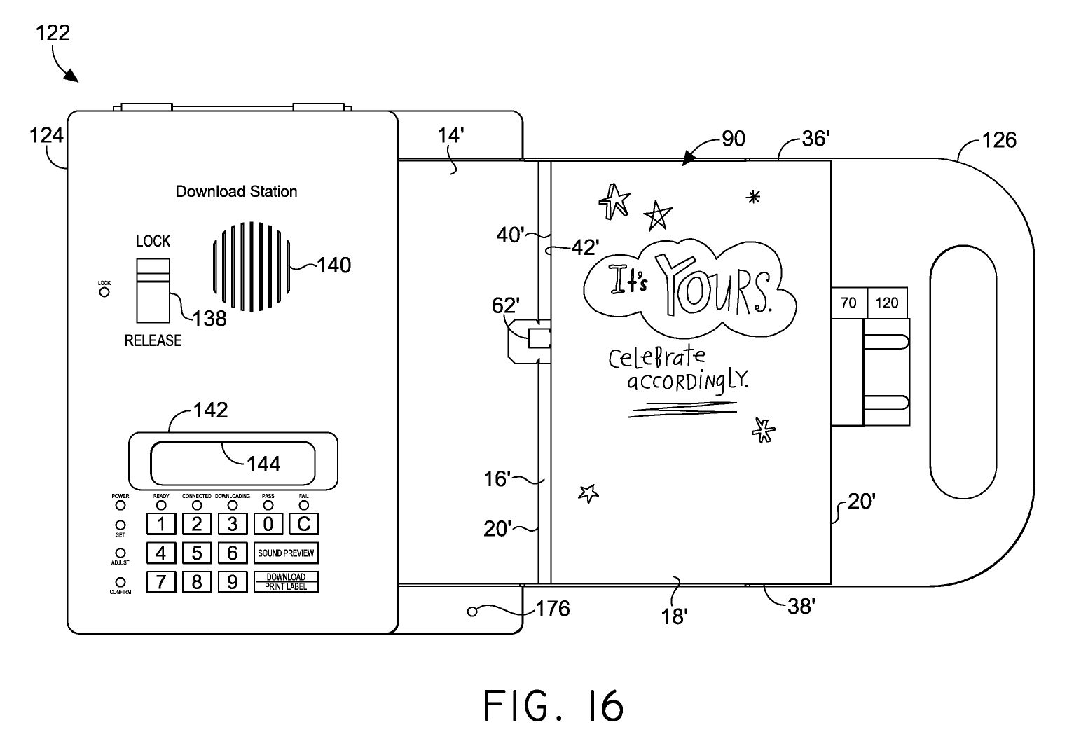

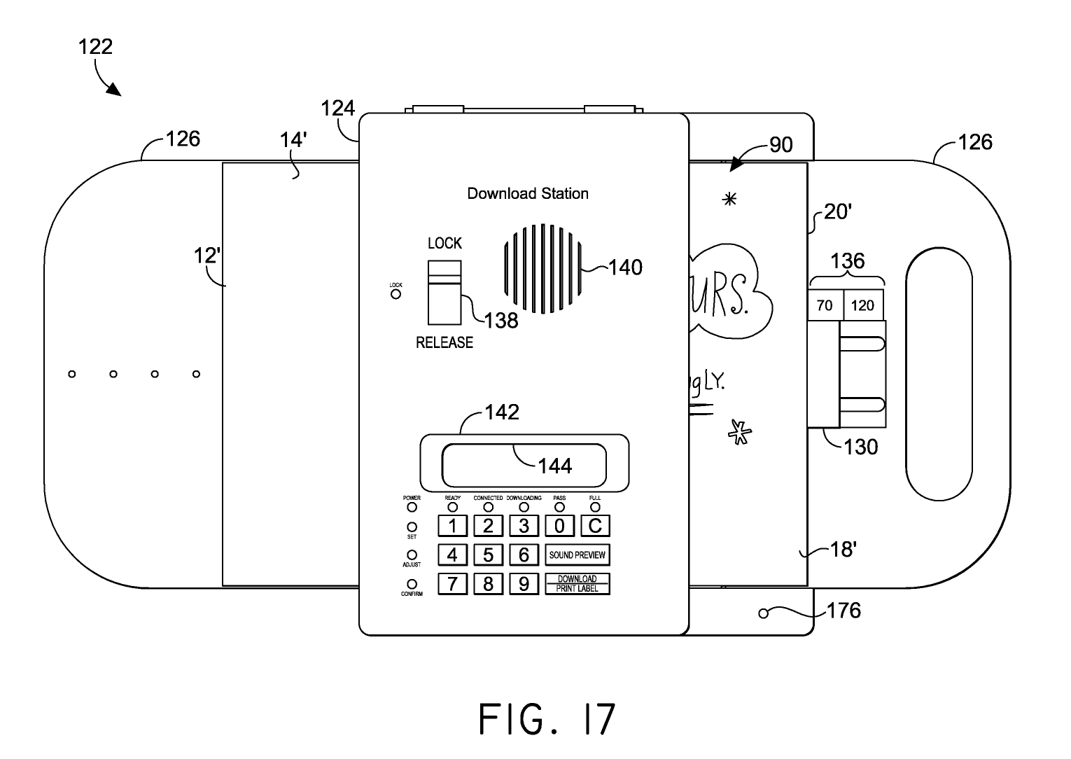

Referring next to FIGS. 16-17, a greeting card 90 is shown placed on the slide tray 126 of the retail download station 122. In FIG. 16, the slide tray 126 is shown fully extended to the right side of the station base 124. As shown in FIG. 17, after being advanced into the station base 124, the slider tray 126 and the greeting card 90 are at least partially received in the station base 124. Once inserted into the station base 124, the lock switch 138 is utilized to secure the slide tray 126 holding the greeting card 90 in the retail download station 122 during download of a song. Also, depicted in FIGS. 16-17, is a low backup battery indicator 176, which notifies a user of the system when the backup battery power is low.

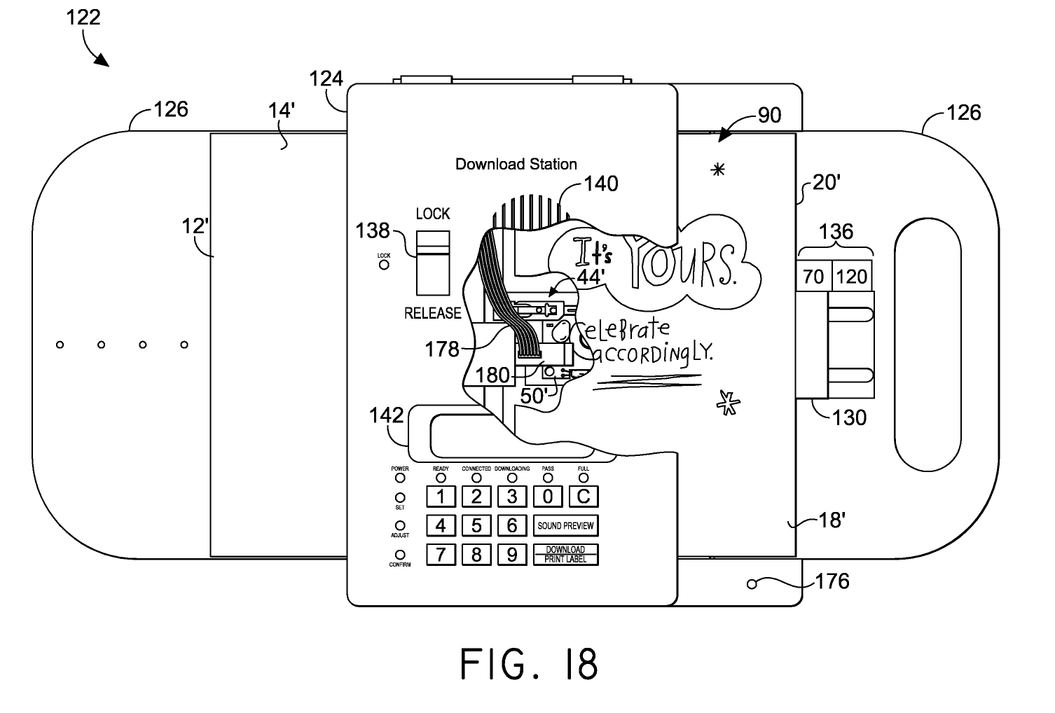

As further illustrated in FIG. 18, the interior of the station base 124 of the retail download station 122, and the interior of the greeting card 90, are shown. The interior of the station base 124 depicts a wiring harness 178 that is electrically coupled to an electrical connector, such as a Pogo pin head 180. When locked into place inside the station base 124, the greeting card 90 is capable of being electrically coupled to the Pogo pin head 180 by way of the Pogo pin head connectors 94 coupled to the circuit board 50′ of the audio receiving and playback device 44′. More simply stated, as the greeting card 90 is moved into the station base 124, the Pogo pin head 180 extends inside the interior pocket 42′ of the greeting card 90 and aligns with and forms an electrical connection with the Pogo pin head connectors 94 of the audio receiving and playback device 44′. It is this connection, once established, that enables the transfer of a selected song from the retail download station 122 onto the greeting card 90. Additionally, by virtue of activating the download/print label button 156, a song is downloaded onto the greeting card 90 and the printer 172 associated with the retail download station 122 prints identifying information 30′.

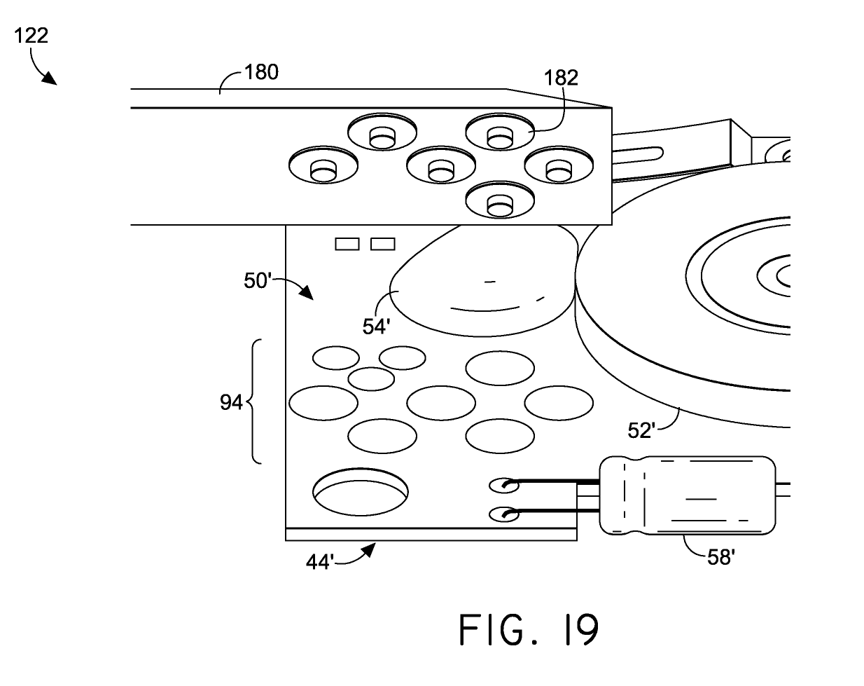

In FIG. 19, an enlarged view of some of the internal components of the retail download station 122 and the greeting card 90 are shown. The underside of the electrical connector/Pogo pin head 180 depicts several male Pogo pin head connectors 182. These connectors 182 align with the Pogo pin head connectors 94 and are used to establish an electrical connection between the retail download station 122 and the audio receiving and playback device 44′ of the greeting card 90. While illustrated in a spaced apart relationship in FIG. 19 to show the alignment, the Pogo pin head connectors 94 are capable of directly contacting the male Pogo pin head connectors 182 of the Pogo pin head 180, thereby creating an electrical connection. By establishing this connection, the retail download station 122 can download a selected song onto the greeting card 90.

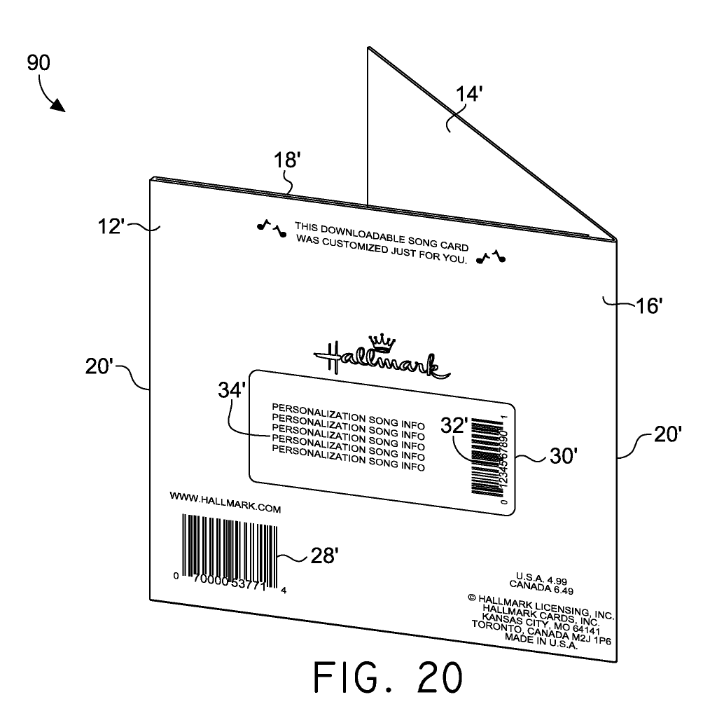

Having downloaded a song onto the greeting card 90, the printer 172 generates identifying information 30′ for affixing to the back of the greeting card 90, as shown in FIG. 20. Such identifying information 30′ may include an identification marking 32′ and identification wording 34′. As similarly discussed with reference to greeting card 10, the identifying information 30′ may be printed onto an individual label, or receipt, that is not affixed to the back of greeting card 90, but is nonetheless utilized to complete the sale of the customized greeting card.

In one embodiment, the purchaser of a greeting card 90 selects a particular song to be downloaded onto the greeting card 90 using the song preview station 104 of the card display fixture 96. The purchaser then takes the greeting card 90 to a cashier's station, where a retail download station 122 is located. The cashier enters the song code associated with the selected song into the retail download station 122 using the numeric buttons 158. If the cashier inputs the incorrect song code, the cashier may then press the clear button 152. Having entered the song code into the retail download station 122, the song code and song name are subsequently displayed on the LCD screen of the song display 142. The cashier may then press the sound preview button 154 to preview the selected song for the purchaser.

Having entered a song selection into the retail download station 122, and optionally previewed the correct entry, the cashier then loads the greeting card 90 onto the slide tray 126 of the retail download station 122, as depicted in FIG. 16. In loading the greeting card 90 onto the slide tray 126, the cashier may pull the slide tray 126 to the right side of the station base 124, and also adjust the card feeders 128 and 130 to fit to the size of the selected greeting card 90. After adjusting the card feeders 128 and 130, and properly positioning the greeting card 90 onto slide tray 126, the cashier then slides the slide tray 126 into the station base 124, as depicted in FIG. 17.

Once the greeting card 90 is properly positioned in the station base 124, the “ready” LED light of the LED download status indicators 150 is illuminated. The cashier then depresses the lock switch 138. The “connected” LED light of the LED download status indicators 150 is then illuminated. The cashier then depresses the download/print label button 156 to start downloading the song onto the greeting card 90. During this process, the “downloading” LED light of the LED download status indicators 150 is illuminated. Based on the download process, either the “pass” or the “fail” LED light of the LED download status indicators 150 is then illuminated.

Upon a successful download of the selected song on to the greeting card 90, a barcode label with identifying information 30′ is printed by the printer 172. The cashier then presses the lock switch 138 to release the slide tray 126 and remove the greeting card 90. The slide tray 126 is then slid to the right side of the station base 124 and the greeting card 90 is removed from the retail download station 122. The cashier may then affix the printed label with identifying information 30′ onto the back of the greeting card 90, as shown in FIG. 20.

The invention described herein has additional benefits over the prior art system of sound modules with a pre-recorded sound file thereon. For example, by being shipped to stores blank (i.e., without a specific song thereon), the sound module can be removed from an unpurchased card and placed in another new card. If it already had a song thereon, it could only be re-used in new cards where the song would be appropriate (i.e., fit with the theme or sentiment of the new card). Further, lost sales resulting from a user liking a card but not the song associated with it can be avoided. Other advantages will become apparent with use of the invention.

From the foregoing it will be seen that this invention is one well adapted to attain all ends and objects hereinabove set forth together with the other advantages which are clear following the complete disclosure above and which are inherent to the methods and apparatuses described herein. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

The invention claimed is:

1. An audio greeting card comprising:
a card body having a plurality of panels; and
an audio receiving and playback device coupled with the card body, the device having a speaker, a power source, a connector capable of receiving audio information, and a first switch for initiating an audio information playback session.

2. The greeting card of claim 1, wherein the card body is formed of a single unitary card blank, wherein the panels are defined by folds in the card blank, wherein first and second panels are separated by a first fold line, wherein the second panel and a third panel are separated by a second fold line, wherein the third panel is folded over and secured with the second panel, thereby creating a pocket, wherein the audio receiving and playback device is positioned within the pocket, and wherein the connector of the audio receiving and playback device is accessible through an opening in a panel of the card body.

3. The greeting card of claim 1, wherein the connector of the audio receiving and playback device is capable of being coupled directly to an audio sending device.

4. The greeting card of claim 1, wherein audio information received by the audio receiving and playback device is automatically played subsequent to movement of two of the panels away from each other.

5. The greeting card of claim 1, wherein the audio receiving and playback device further comprises a microphone and a second switch for initiating an audio message recording session.

6. The greeting card of claim 5, wherein an audio message recorded by the audio receiving and playback device is automatically played before and/or subsequent to playback of the audio information received by the audio receiving and playback device.

7. A method of sending audio information to greeting cards using an audio sending device, comprising:
receiving a greeting card having an audio information receiving and playback device coupled to the greeting card;
receiving an audio information selection indicating particular audio information to send to the greeting card;
sending the selected audio information to the greeting card; and
based on the selected audio information sent to the greeting card, generating identifying information regarding the audio information sent to the greeting card.

8. The method of claim 7, wherein receiving a greeting card having an audio receiving and playback device includes:
coupling an audio sending device to a connector of the audio receiving and playback device.

9. The method of claim 7, wherein receiving an audio information selection includes:
providing one or more audio information items to a user; and
receiving an indication of a user selection of one or more of the audio information items.

10. The method of claim 7, wherein the method further comprises printing the generated identifying information on a label, the label adapted to adhere to the back of the greeting card.

11. The method of claim 7, wherein the method further comprises printing the generated identifying information on a non-adhesive label.

12. The method of claim 7, wherein the method further comprises printing the identifying information directly on the greeting card.

13. The method of claim 7, wherein the method further comprises sending the generated identifying information to a database.

14. The method of claim 7, wherein the identifying information includes identification wording and wherein the identification wording includes one or more of the following: the name of an artist of the selected audio information that was sent to the greeting card, the title of the song, the author, copyright information, ownership information, licensing information, and legal information.

15. The method of claim 7, wherein the identifying information comprises an identification marking associated with the audio information sent to the greeting card.

16. A system for sending audio information to greeting cards comprising:
an audio greeting card for receiving audio information, the greeting card comprising a card body having a plurality of panels and an audio receiving and playback device coupled with the card body, the device having a speaker, a power source, and a connector capable of receiving audio information;
an audio sending component for sending audio information to the audio greeting card and generating identifying information based on the sent audio information; and
a purchasing component for receiving the identifying information generated by the audio sending component.

17. The system of claim 16, further comprising:
a database coupled to the purchasing component for receiving the identifying information received by the purchasing component.

18. The system of claim 16, wherein the audio sending component is further configured to print the identifying information generated by the audio sending component on a label, the label adapted to adhere to the back of the greeting card.

19. The system of claim 16, wherein the audio sending component is further configured to print the identifying information generated by the audio sending component directly on the greeting card.

20. The system of claim 16, wherein the audio sending component is configured to send audio information to the greeting card by coupling to the connector of the audio receiving and playback device.
